(19) United States
(12) Patent Application Publication
(10) Pub. No.: US 2020/0322149 A1
(43) Pub. Date: Oct. 8, 2020

(54) ELECTRONIC CHIP WITH COMMUNICATION INTERFACES

(71) Applicant: STMicroelectronics (Rousset) SAS, Rousset (FR)

(72) Inventors: Alexandre Tramoni, Le Beausset (FR); Christophe Laurencin, Peypin (FR)

(21) Appl. No.: 16/815,835

(22) Filed: Mar. 11, 2020

(30) Foreign Application Priority Data
Apr. 8, 2019 (FR) 1903722

(51) Int. Cl. H04L 9/32; G06K 19/077

(52) U.S. Cl. CPC H04L 9/321; H04L 9/3234; G06K 19/07769; G06K 19/07732; H04L 9/3271

(57) ABSTRACT

An electronic chip with a communication interface is disclosed. In an embodiment, an electronic device includes an electronic chip having a plurality of ISO/IEC 7816 standardized interfaces.

### CROSS-REFERENCE TO RELATED APPLICATIONS

This application claims priority to French Patent Application No. 1903722, filed on Apr. 8, 2019, which application is hereby incorporated herein by reference.

### TECHNICAL FIELD

The present description generally relates to electronic devices, and more specifically the systems in which electronic components are interconnected by ISO/IEC 7816 standardized links.

### BACKGROUND

ISO/IEC 7816 standardized links are already widely used to connect several electronic circuits of a same system to one another. Portable electronic devices in particular exist including several subscriber identity modules (SIM) each connected, by means of an ISO/IEC 7816 standardized link, to a dedicated modulator-demodulator (modem) circuit.

### SUMMARY

Embodiments provide optimization of the existing communication devices and methods that implement ISO/IEC 7816 standardized links.

One embodiment overcomes all or some of the drawbacks of the known communication devices and methods.

One embodiment provides an electronic device comprising an electronic chip including a plurality of ISO/IEC 7816 standardized interfaces.

One embodiment provides a communication method, in which a same electronic chip controls a plurality of ISO/IEC 7816 standardized interfaces.

According to one embodiment, the electronic chip is an embedded subscriber identity module.

According to one embodiment, the electronic chip is integrated into a package.

According to one embodiment, the package is mounted on an electronic circuit board.

According to one embodiment, each ISO/IEC 7816 standardized interface is configured to communicate with a dedicated modulator-demodulator circuit.

According to one embodiment, a near-field communication module is configured to supply power to the electronic chip.

According to one embodiment, each modulator-demodulator circuit is configured to supply power to the communication module in the near field.

According to one embodiment, the electronic chip includes:
at least one processing unit;
at least one cryptographic module;
at least two communication modules dedicated to ISO/IEC 7816 standardized interfaces; and
at least one internal communication bus; and/or
at least one non-volatile memory storage area; and/or
at least one volatile memory storage area.

One embodiment provides a mobile telephone consisting of such a device.

One embodiment provides a mobile telephone configured to implement a method as described.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 shows, schematically and in block form, an exemplary device including ISO/IEC 7816 standardized links;

FIG. 2 shows, schematically and in block form, an embodiment of a device including ISO/IEC 7816 standardized links;

FIG. 3 shows, schematically and in block form, an embodiment of electronic circuits coupled by ISO/IEC 7816 standardized links;

FIG. 4 shows, schematically and in block form, an embodiment of an electronic chip of an embedded subscriber identity module;

FIG. 5 shows, schematically and in block form, another embodiment of an electronic chip of an embedded subscriber identity module; and

FIG. 6 shows an exemplary system including an embedded subscriber identity module.

Like features have been designated by like references in the various figures. In particular, the structural and/or functional features that are common among the various embodiments may have the same references and may dispose identical structural, dimensional and material properties.

### DETAILED DESCRIPTION OF ILLUSTRATIVE EMBODIMENTS

For the sake of clarity, only the operations and elements that are useful for an understanding of the embodiments described herein have been illustrated and described in detail. In particular, the generation of the signals to be transmitted by the ISO/IEC 7816 standardized links and the processing of these signals by the various circuits connected to one another by these links are not described in detail, the described embodiments being compatible with the typical transmissions between two or more circuits over ISO/IEC 7816 standardized links.

Unless indicated otherwise, when reference is made to two elements connected together, this signifies a direct connection without any intermediate elements other than conductors, and when reference is made to two elements linked or coupled together, this signifies that these two elements can be connected or they can be linked or coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless otherwise specified, the expressions “around”, “approximately”, “substantially” and “in the order of” mean to within 10%, preferably to within 5%.

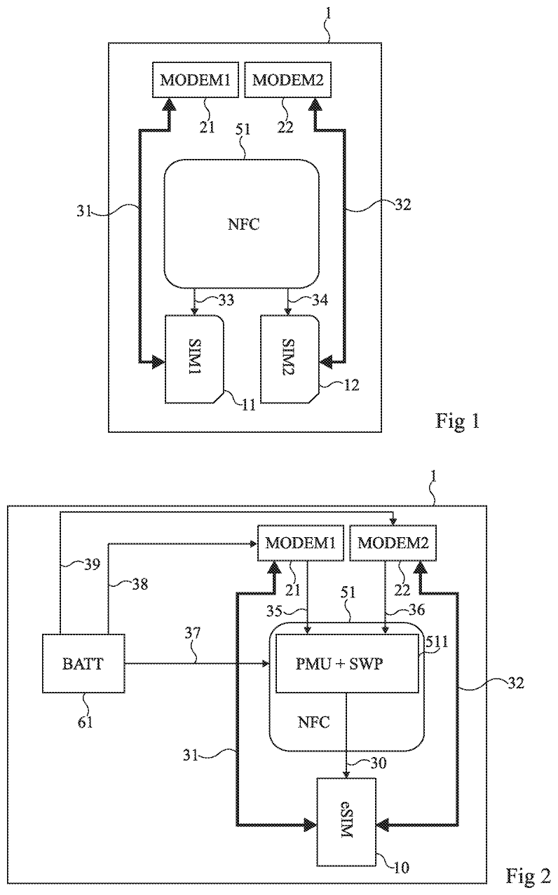

FIG. 1 shows, schematically and in block form, an exemplary device 1 including ISO/IEC 7816 standardized links.

In this example, the device 1 (for example, a portable electronic device, for instance a mobile telephone, a smartphone or a touch-sensitive tablet) includes two subscriber identity cards 11 (SIM1) and 12 (SIM2), or SIM cards (Subscriber Identity Module). The two SIM cards 11 and 12 are respectively coupled (two-way arrows 31 and 32), preferably connected, to modulator-demodulator circuits 21 (MODEM1) and 22 (MODEM2), or modems, that are dedicated to them. In FIG. 1, the arrows 31 and 32 each represent an ISO/IEC 7816 normalized link. In other words: the SIM card 11 is connected to the modem 21 by means of the ISO/IEC 7816 standardized link 31; and the SIM card 12 is connected to the modem 22 by means of the ISO/IEC 7816 standardized link 32.

The SIM cards 11 and 12 are furthermore respectively coupled (arrows 33 and 34), preferably connected, to a near-field communication (NFC) module 51 supplying them with power. In FIG. 1, the arrows 33 and 34 each represent a link configured to convey electrical power. In other words: the near-field communication module 51 supplies electricity to the SIM card 11 via the link 33; and the near-field communication module 51 supplies electricity to the SIM card 12 via the link 34.

Configurations also exist in which the device 1 is devoid of the near-field communication module 51. The SIM cards 11 and 12 are, if applicable, each supplied by a separate link (not shown) coming from the modem 21, for the SIM card 11, and from the modem 22, for the SIM card 12.

In the example of FIG. 1, the SIM cards 11 and 12 are removable chip cards (Universal Integrated Circuit Card—UICC). The SIM cards 11 and 12 are typically inserted into appropriate slots or housings (not shown) of the device 1.

Each SIM card 11, 12 generally contains information specific to a contract or subscription acquired by a subscriber from an operator or access provider (for example, a mobile telephone network operator or an Internet access provider). This information for example takes the form of a country code, an identifier specific to the operator and an identifier specific to the subscriber.

In the example of FIG. 1, the SIM cards 11 and 12 allow the device 1 to connect simultaneously, by means of the modems 21 and 22, to two wireless networks (not shown). These two networks are generally separate. For example, these networks belong to different operators, or are used by different operators. A user of the device 1 is thus able to exchange information (for example, voice, messages and/or data) with other users via these two networks.

FIG. 2 shows, schematically and in block form, an embodiment of a device including ISO/IEC 7816 standardized links.

According to this preferred embodiment, a single embedded subscriber identity module (eSIM) 10 replaces the two SIM cards 11 and 12 (FIG. 1).

In the example of FIG. 2, the subscriber identification module 10 is a non-removable embedded universal integrated circuit card (eUICC). Such a configuration in particular procures, for the device 1, better resistance to mechanical stresses relative to the example described in connection with FIG. 1. The module 10 being fixed to the device 1, vibrations are in particular not very likely to affect an electrical continuity in contact areas (not shown) located between the module 10 and the links 31 and 32. One thus improves a usage continuity of the device 1.

The device 1 includes modems 21 and 22 of the type of those described in connection with FIG. 1 and a near-field communication (NFC) module 51. The module 51 includes an element 511 (PMU+SWP) provided, for example, with a Power Management Unit (PMU) and a communication module for example implementing a protocol of the SWP (Single Wire Protocol) type.

The near-field communication module 51 of the device 1 draws its electrical power: either from an electrical energy source 61 (BATT) (for example, a battery embedded in the device 1) (arrow 37); or from modems 21 and 22 (arrows 35 and 36).

In the example of FIG. 2, the embedded subscriber identity module 10 draws its electrical power from the element 511 (arrow 30) associated with the near-field communication module 51. The two power supply links 33 and 34 (FIG. 1) are thus replaced, in FIG. 2, by a single link 30.

The embedded subscriber identity module 10 may, as a result, benefit from three redundant supply channels: a first supply channel coming from the modem 21 connected to the electrical energy source 61 (ink 38) directly using the ISO/IEC 7816 standardized link 31; a second supply channel coming from the modem 22 connected to the electrical energy source 61 (ink 39) directly using the ISO/IEC 7816 standardized link 32; and a third supply channel coming from the modems 21 and 22 connected to the electrical energy source 61 (links 38 and 39, respectively) indirectly supplying the embedded subscriber identity module 10 by means of the element 511 of the near-field communication module 51.

The embedded subscriber identity module 10 preferably has functionalities similar to those of the SIM cards 11 and 12, as described in connection with FIG. 1. This then has several advantages: the two SIM cards 11 and 12 (FIG. 1) are replaced by a single module 10, which can decrease the design and manufacturing costs of the device 1; the module 10 generally occupies a surface area smaller than that of the two SIM cards 11 and 12 (FIG. 1) combined, which can allow an integration of the module 10 into a smaller device 1; and the module 10 is installed in the device 1 permanently, which avoids any manipulation of the subscriber identity module by the user, and thus reduces the risks of damage and failure.

In a variant, the embedded subscriber identity module 10 is connected, by means of one or more other ISO/IEC 7816 standardized links (not shown), to one or more other modems (not shown). The device 1 is then configured to connect to a number of networks identical to a number of modems and ISO/IEC 7816 standardized links equipping the device 1.

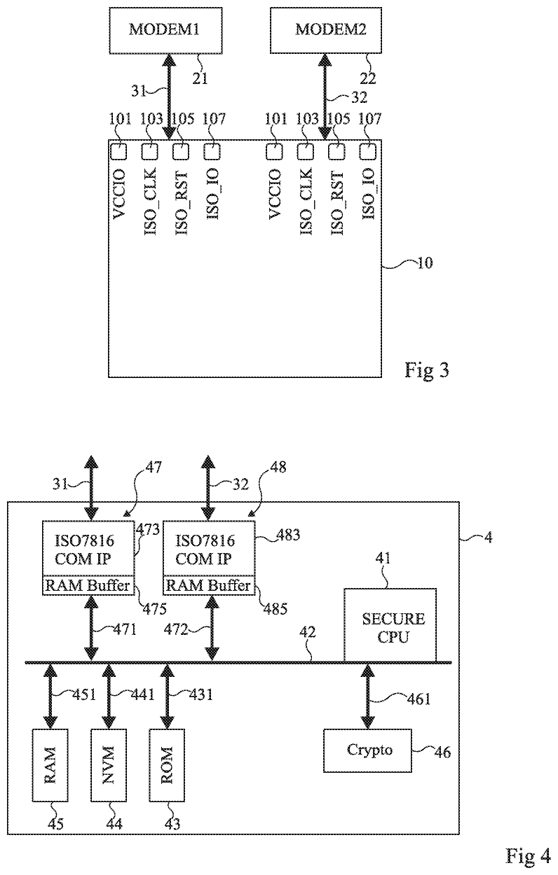

FIG. 3 shows, schematically and in block form, an embodiment of electronic circuits coupled by ISO/IEC 7816 standardized links.

According to this embodiment, the embedded subscriber identity module 10 consists of an embedded universal integrated circuit card (eUICC). This circuit 10 exchanges information with the modem 21 (MODEM1) and with the modem 22 (MODEM2). According to one preferred embodiment, the exchanges between the circuit 10 and the two modems 21 and 22 take place simultaneously. The exchanges between the circuit 10 and the modems 21 and 22 are respectively carried by the ISO/IEC 7816 standardized links 31 and 32.

The modems 21 and 22 are for example configured to establish a communication with two mobile telephone networks (not shown). The modems 21 and 22 thus allow the circuit 10 to exchange data (for example, data representative of voice signals, messages, etc.) with these two networks.

In the example of FIG. 3, each ISO/IEC 7816 standardized link 31,32 is connected to the circuit 10 by a set of contact elements or contacts 101,103,105 and 107. Each set consists of: a contact 101 (VCCIO) on which a supply signal is applied; a contact 103 (ISO_CLK) on which a synchronization signal or a clock signal is applied; a contact 105 (ISO_RST) on which a reset signal is applied; and an input-output contact 107 (ISO_IO) on which a signal representative of information to be sent is applied.

The contacts 101,103,105 and 107 thus allow the circuit 10 to be supplied by the modems 21 and 22 (links 31 and 32, respectively) and to exchange information with these same modems 21 and 22. According to another embodiment, the circuit 10 includes other contacts (not shown), in particular a ground contact brought to a reference potential.

FIG. 4 shows, schematically and in block form, an embodiment of an electronic chip of an embedded subscriber identity module.

According to this embodiment, an electronic chip 4 includes a processing unit 41 (SECURE CPU), or microprocessor, or microcontroller, or computer. This processing unit 41 is coupled, preferably connected, to a communication bus 42 inside the chip 4. The processing unit 41 of the chip 4 is for example configured to control the timing of or organize data exchanges on the internal communication bus 42.

Memory zones (or memory circuits) for non-volatile storage (block 43, ROM or block 44, NVM) and/or volatile storage (block 45, RAM) are also coupled, preferably connected (links 431,441 and 451, respectively), to the internal bus 42. A cryptographic module 46 (Crypto) is also coupled, preferably connected (link 461), to the internal bus 42.

In the example of FIG. 4, the chip 4 further includes two ISO/IEC 7816 standardized interfaces 47 and 48. The two interfaces 47 and 48 allow in particular the processing unit 41 to exchange data on the ISO/IEC 7816 standardized links (not shown). These two interfaces 47 and 48 are each for example composed of:
a module 473, respectively 483 (ISO7816 COM IP) dedicated to performing communication functions of the chip 4 on an ISO/IEC 7816 standardized link;
a module 475, respectively 485 (RAM Buffer) forming a buffer memory zone.

According to one preferred embodiment, the chip 4 forms the embedded subscriber identity module 10 (FIGS. 2 and 3). The chip 4 is, if applicable, integrated into a package (not shown) mounted on an electronic circuit board (not shown). The two ISO/IEC standardized interfaces 47 and 48 then allow the circuit 4 to communicate with the modems 21 and 22 by means of the links 31 and 32, respectively.

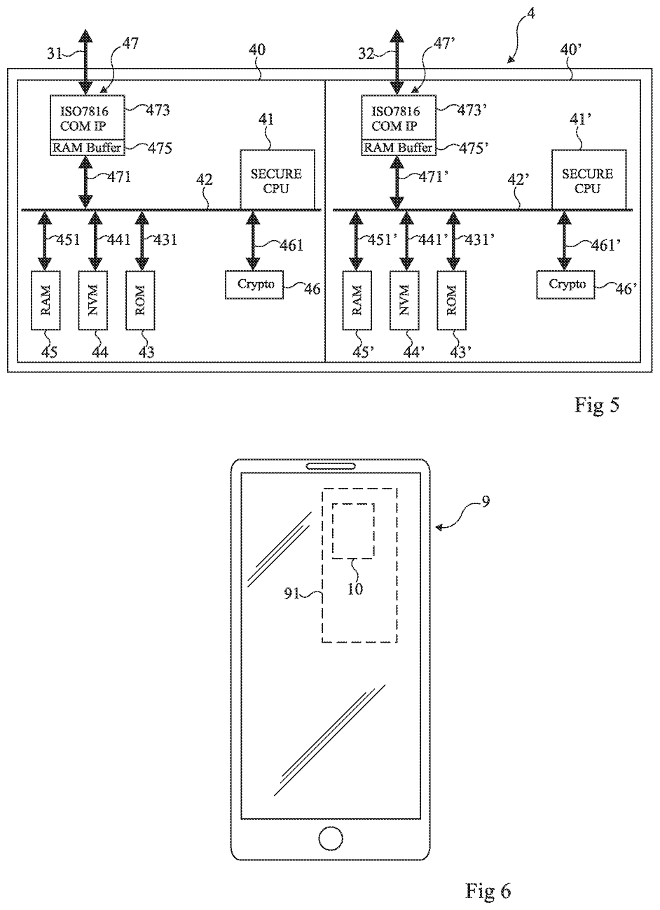

FIG. 5 shows, schematically and in block form, another embodiment of an electronic chip 4 of an embedded subscriber identity module.

According to this embodiment, the electronic chip 4 is composed of two functional units 40 and 40′. The functional unit 40 encompasses most of the component elements of the chip 4 previously described in connection with FIG. 4, with the exception of the ISO/IEC 7816 standardized interface 48 and the link 472 which, in FIG. 5, the functional unit 40 is lacking.

The functional unit 40 is composed as follows:
the processing unit 41 coupled, preferably connected, to the internal communication bus 42;
memory zones (or memory circuits) for non-volatile storage 43, 44 and/or volatile storage 45 coupled, preferably connected (links 431, 441 and 451, respectively), to the internal bus 42 of the functional unit 40;
the cryptographic module 46, which is also coupled, preferably connected (link 461), to the internal bus 42; and
the ISO/IEC 7816 standardized interface 47, made up of the modules 473 and 475, and coupled, preferably connected (link 471), to the internal bus 42.

The functional unit 40′ is similar to the functional unit 40. The functional unit 40′ is composed as follows:
a processing unit 41′ (SECURE CPU) coupled, preferably connected, to a communication bus 42′ inside the functional unit 40′;
memory zones (or memory circuits) for non-volatile storage (block 43′, ROM or block 44′, NVM) and/or volatile storage (block 45′, RAM) coupled, preferably connected (links 431′, 441′ and 451′, respectively), to the internal bus 42′ of the functional unit 40′;
a cryptographic module 46′ (Crypto), which is also coupled, preferably connected (link 461′), to the internal bus 42′; and
an ISO/IEC 7816 standardized interface 47, made up of two modules 473′ (ISO7816 COM IP) and 475′ (RAM Buffer), coupled, preferably connected (link 471′), to the internal bus 42′.

In other words, the two functional units 40 and 40′ of the circuit 4 each have a processor 41,41′ allocated to controlling an ISO/IEC 7816 standardized interface 47, 47′.

According to one preferred embodiment, the chip 4 is integrated into a package (not shown) and thus makes up a circuit, for example the embedded subscriber identity module 10 (FIGS. 2 and 3). The two ISO/IEC 7816 standardized interfaces 47 and 47 then allow the circuit 4 of the module 10 to communicate with the modems 21 and 22 by means of links 31 and 32, respectively.

FIG. 6 shows an exemplary system comprising an embedded subscriber identity module.

In the example of FIG. 6, portable electronic equipment 9 or a mobile terminal (for example, a mobile telephone, a smartphone or a touch-sensitive tablet) includes an electronic circuit board 91 (for example, a motherboard or a board configured to provide communication functionalities). The embedded subscriber identity module 10 is mounted on the electronic circuit board 91. The module 10 is configured to connect the equipment 9 to at least two distinct communication networks (not shown). A user is therefore able to exchange, preferably simultaneously, data on a plurality of communication networks from a same terminal 9. The equipment 9 is thus configured to implement the described method.

Various embodiments and variants have been described. One skilled in the art will understand that certain features of these different embodiments and variants could be combined, and other variants will appear to one skilled in the art. In particular, the embodiments described in connection with FIGS. 4 and 5 can be combined in order to obtain, for example, the electronic chip 4 including processing units 41 and 41′ controlling each of a plurality of ISO/IEC 7816 standardized interfaces.

Lastly, the practical implementation of the described embodiments and variants is within the capabilities of one skilled in the art from the functional indications provided above. In particular, the number of ISO/IEC 7816 standardized interfaces included in each circuit can be increased in order to adapt, for example, to the communication needs of a device including more than two modems.

What is claimed is:

1. An electronic device comprising:
an electronic chip including a plurality of ISO/IEC 7816 standardized interfaces.

2. The device according to claim 1, wherein the electronic chip is an embedded subscriber identity module.

3. The device according to claim 1, wherein the electronic chip is integrated into a package.

4. The device according to claim 3, wherein the package is mounted on an electronic circuit board.

5. The device according to claim 1, wherein each ISO/IEC 7816 standardized interface is configured to communicate with a dedicated modulator-demodulator circuit.

6. The device according to claim 1, further comprising a near-field communication module configured to supply power to the electronic chip.

7. The device according to claim 6, further comprising plurality of modulator-demodulation circuits, wherein each modulator-demodulator circuit is configured to supply power to the near-field communication module.

8. The device according to claim 1, wherein the electronic chip comprises:
at least one secure processing unit;
at least one cryptographic module;
at least two communication modules dedicated to the ISO/IEC 7816 standardized interfaces; and
at least one internal communication bus; and/or
at least one non-volatile memory storage area; and/or
at least one volatile memory storage area.

9. A communication method comprising:
controlling, by an electronic chip, a plurality of ISO/IEC 7816 standardized interfaces.

10. The method according to claim 9, wherein the electronic chip is an embedded subscriber identity module.

11. The method according to claim 9, wherein the electronic chip is integrated into a package.

12. The method according to claim 11, wherein the package is mounted on an electronic circuit board.

13. The method according to claim 9, wherein each ISO/IEC 7816 standardized interface communicates with a dedicated modulator-demodulator circuit.

14. The method according to claim 9, further comprising:
supplying, by a near-field communication module, power to the electronic chip.

15. The method according to claim 14, further comprising:
supplying, by a plurality of modulator-demodulator circuits, power to the near-field communication module.

16. The method according to claim 9, wherein the electronic chip comprises:
at least one secure processing unit;
at least one cryptographic module;
at least two communication modules dedicated to the ISO/IEC 7816 standardized interfaces; and
at least one internal communication bus; and/or
at least one non-volatile memory storage area; and/or
at least one volatile memory storage area.

17. An electronic device comprising:
an electronic circuit board;
an electronic chip including a plurality of ISO/IEC 7816 standardized interfaces, wherein the electronic chip is an embedded subscriber identity module, wherein the electronic chip is integrated into a package, and wherein the package is mounted on the electronic circuit board;
modulation-demodulation circuits, wherein each ISO/IEC 7816 standardized interface is electrically connected with a dedicated modulator-demodulator circuit of the modulation-demodulation circuits; and
a near-field communication module configured to supply power to the electronic chip.

18. The device according to claim 17, wherein each modulator-demodulator circuit is configured to supply power to the near-field communication module.

19. The device according to claim 17, further comprising an electrical energy source configured to supply power to the near-field communication module.
